(19) United States
(12) Patent Application Publication
(10) Pub. No.: US 2019/0381585 A1
(43) Pub. Date: Dec. 19, 2019

(54) VANE CUTTING APPARATUS

(71) Applicant: DURO DYNE CORPORATION, Bay Shore, NY (US)

(72) Inventors: Andrew J. BELLISE, Farmingdale, NY (US); Ainsley F. SMITH, Springfield Gardens, NY (US); David B. KRUPNICK, Mattituck, NY (US)

(73) Assignee: DURO DYNE CORPORATION, Bay Shore, NY (US)

(21) Appl. No.: 16/476,432

(22) PCT Filed: Jan. 26, 2018
(86) PCT No.: PCT/US2018/015347

§ 371 Date: Jul. 8, 2019

Related U.S. Application Data
(60) Provisional application No. 62/450,725, filed on Jan. 26, 2017.

(51) Int. Cl. B23D 23/00; B23D 15/04; B23D 15/14; B23D 33/10; B23D 33/12

(52) U.S. Cl. CPC B23D 23/00; B23D 15/04; B23D 33/12; B23D 33/10; B23D 15/14

(57) ABSTRACT

The present disclosure relates to apparatus and methods for cutting a hollow turning vane to a desired length for use in a heating, ventilation, and air conditioning (HVAC) system. The vane cutting apparatus disclosed herein utilizes a pneumatically powered cutting mechanism that allows for a smaller apparatus footprint with no loss of cutting force and results in the single stepped blade rolling the inside edges of the hollow turning vane during cutting. The rolled inside edges provide a more secure and smoother fit when the hollow turning vane is fastened to the mating vane rail for use in an HVAC duct.

### FIELD

The present disclosure relates to apparatus and methods for cutting a hollow turning vane to a desired length for use in a heating, ventilation, and air conditioning (HVAC) system.

### BACKGROUND

Hollow turning vanes are used in the ductwork of HVAC systems to smoothly direct airflow when there is a change in direction, for example, around an intersection or corner in the ductwork.

In the HVAC industry, cutting hollow turning vanes to a size for use in ductwork often includes the use of a hand or powered abrasive cut-off saw. Cutting hollow turning vanes in this manner often leads to a distortion of the exposed cut vane edges and the possibility of an unsmooth surface that may not be at a ninety degree angle to the vane. Along with the potential for decreased quality, using the abrasive cut-off saw may also increase the time of production, cost of labor, and in some cases reduced safety for the cutting operator.

### BRIEF SUMMARY

The apparatus and method described herein performs hollow turning vane cutting using a pneumatically powered cutting mechanism. In some aspects, the pneumatically powered cutting mechanism uses 70 psi supplied to a single stage 5″ bore 3″ stroke cylinder. The pneumatically powered cutting mechanism allows for a smaller apparatus footprint with no loss of cutting force, resulting in the single stepped blade rolling the inside edges of the hollow turning vane during cutting. The rolled inside edges provide a more secure and smoother fit when the hollow turning vane is fastened to the mating vane rail for use in an HVAC duct.

In some aspects, the apparatus uses a 110 volt source controlled by an on/off toggle switch which when turned to the “on” position initiates a power indicator lamp. The apparatus is configured to be cycled for a single cutting stroke only when an operator actuates two momentary switches simultaneously, one with each hand. This provides a mechanism to enhance operator safety by ensuring that both of the operator's hands are located away from the blade during operation. In some aspects, the apparatus further includes a hinged exit gravity close door that closes after each hollow turning vane is cut to further ensure operator safety. In some aspects, the apparatus includes a manual stop that may be set for length of cut in a simple and efficient manner by loosening a ½″ collar and stop set screws without electric or pneumatic encumbrances.

In some aspects, the apparatus uses a reversible single stepped cutting blade to pneumatically cut the hollow turning vane. The reversible single stepped cutting blade is resharpenable and provides a longer life of the blade function during production.

In some aspects, the apparatus provides for simple and safe operation during the cutting of hollow turning vanes using a relatively small set of moving parts in a compact bench-top securable design.

In an aspect of the present disclosure, an apparatus for hollow turning vane cutting is disclosed. In an aspect, the apparatus includes a fluid source, a pneumatic piston fluidly coupled to the fluid source and a vane cutter blade mechanically coupled to the pneumatic piston. The pneumatic piston is configured to actuate the vane cutter blade between at least a proximal position and a distal position. Actuation of the vane cutter blade toward the distal position is configured to cut a hollow turning vane. The apparatus further includes a fluid control mechanism fluidly disposed between the fluid source and the pneumatic piston. The fluid control mechanism is configured to control a supply of fluid from the fluid source to the pneumatic piston. The apparatus further includes an actuation mechanism electrically coupled to the fluid control mechanism and activatable to cause the fluid control mechanism to supply fluid to the pneumatic piston. The pneumatic piston is configured to actuate the vane cutter blade when the fluid control mechanism supplies the fluid to the pneumatic piston.

In some aspects, the vane cutting apparatus may further include a blade saddle. The blade saddle may include a first member and a second member. The blade saddle is configured to receive at least a portion of the vane cutter blade between the first member and the second member when the vane cutter blade is actuated toward the distal position.

In some aspects, the blade saddle may include an arcuate portion. The arcuate portion is configured to support the hollow turning vane and inhibit deformation of the hollow turning vane when the vane cutter blade cuts the hollow turning vane.

In some aspects, the vane cutting apparatus may further include a material stop. The material stop is configured to abut the hollow turning vane when the hollow turning vane is positioned for cutting by the vane cutter blade. A position of the material stop may be adjustable to set a desired length of the hollow turning vane.

In some aspects, the vane cutting apparatus may further include an exit track that is configured to support the hollow turning vane on a downstream side of the cutter blade. The position of the material stop may be adjustable relative to the exit track to set the desired length. The material stop may be configured for securement to the exit track to inhibit movement of the material stop relative to the exit track.

In some aspects, the exit track may include measurement indicia. The position of the material stop may be adjustable relative to the measurement indicia to set the desired length of the hollow turning vane based on the measurement indicia.

In some aspects, the vane cutting apparatus may further include a material feed track that is configured to support the hollow turning vane on an upstream side of the cutter blade.

In some aspects, the material feed track may include a first side and a second side at an angle to the first side, the first and second sides may be configured to support the hollow turning vane therebetween when the hollow turning vane is inserted into the vane cutting apparatus in a downstream direction.

In some aspects, the first side may include a first flange attached to an end thereof and the second side may include a second flange attached to an end thereof. The first and second flanges are configured to, when the hollow turning vane is supported on the first and second sides and proximate to the first and second flanges, inhibit removal of the hollow turning vane from the material feed track in a direction orthogonal to the downstream direction.

In an aspect, a vane cutting apparatus is disclosed. The vane cutting apparatus includes a blade saddle. The blade saddle includes a first member and a second member and is configured to support a hollow turning blade when the hollow turning blade is received within the vane cutting apparatus. The vane cutting apparatus further includes a pneumatic piston fluidly coupled to a fluid source and a vane cutter blade mechanically coupled to the pneumatic piston. The pneumatic piston is configured to actuate the vane cutter blade between at least a proximal position and a distal position. At least a portion of vane cutter blade is received between the first and second members of the blade saddle when in the distal position. Actuation of the vane cutter blade toward the distal position is configured to cut the hollow turning vane supported by the blade saddle.

In some aspects, the vane cutting apparatus may further include a fluid control mechanism fluidly disposed between the fluid source and the pneumatic piston. The fluid control mechanism is configured to control a supply of fluid from the fluid source to the pneumatic piston. The vane cutting apparatus may further include an actuation mechanism electrically coupled to the fluid control mechanism and activatable to cause the fluid control mechanism to supply fluid to the pneumatic piston. The pneumatic piston is configured to actuate the vane cutter blade when the fluid control mechanism supplies the fluid to the pneumatic piston.

In some aspects, the blade saddle may include an arcuate portion, the arcuate portion is configured to support the hollow turning vane and inhibit deformation of the hollow turning vane when the vane cutter blade cuts the hollow turning vane.

In some aspects, the vane cutting apparatus may further include a material stop. The material stop is configured to abut the hollow turning vane when the hollow turning vane is positioned for cutting by the vane cutter blade. A position of the material stop may be adjustable to set a desired length of the hollow turning vane.

In some aspects, the vane cutting apparatus may further include an exit track that is configured to support the hollow turning vane on a downstream side of the cutter blade. The position of the material stop may be adjustable relative to the exit track to set the desired length. The material stop may be configured for securement to the exit track to inhibit movement of the material stop relative to the exit track.

In some aspects, the exit track may include measurement indicia. The position of the material stop may be adjustable relative to the measurement indicia to set the desired length of the hollow turning vane based on the measurement indicia.

In aspects of the present disclosure, apparatus, systems, and methods in accordance with the above aspect may also be provided. Any of the above aspects may be combined without departing from the scope of the present disclosure.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 is an image of a vane cutting apparatus in accordance with an aspect of the present disclosure.

FIG. 2 is another image of the vane cutting apparatus of FIG. 1.

FIG. 3 is an exploded view of the vane cutting apparatus of FIG. 1.

FIG. 4 is a system diagram of a pneumatic system of the vane cutting apparatus of FIG. 1 in accordance with an aspect of the present disclosure.

FIGS. 5-7 are front and side views of a material feed track assembly of the vane cutting apparatus of FIG. 1.

FIG. 8 is a front and side view of a safety door track of the vane cutting apparatus of FIG. 1.

FIGS. 9 and 10 are front, top, and side views of a control console of the vane cutting apparatus of FIG. 1.

FIGS. 11 and 12 are front and top views of a sub-component assembly of the vane cutting apparatus of FIG. 1.

FIG. 13 is a front, top, and side view of an upper plate of the vane cutting apparatus of FIG. 1.

FIG. 14 is a front, top, and side view of a lower plate of the vane cutting apparatus of FIG. 1.

FIG. 15 is a front, top, side, and section view of a blade saddle of the vane cutting apparatus of FIG. 1.

FIG. 16 is a front, top, and side view of a blade holder of the vane cutting apparatus of FIG. 1.

FIG. 17 is a front, side, and section view of vane cutter blade of the vane cutting apparatus of FIG. 1.

FIG. 18 is a control side view of a vane cutting apparatus according to some aspects of the present disclosure.

FIG. 19 is an exit side view of the vane cutting apparatus of FIG. 18 according to some aspects of the present disclosure.

FIG. 20 is a non-control side view of the vane cutting apparatus of FIG. 18 according to some aspects of the present disclosure.

FIG. 21 is a feed side view of the vane cutting apparatus of FIG. 18 according to some aspects of the present disclosure.

FIG. 22 is an exploded view of the vane cutting apparatus of FIG. 18 according to some aspects of the present disclosure.

FIG. 23 is a front, top, and side view of a material feed track assembly of the vane cutting apparatus of FIG. 18 according to some aspects of the present disclosure.

FIG. 24 is a front, top, and side view of an exit track assembly of the vane cutting apparatus of FIG. 18 according to some aspects of the present disclosure.

FIG. 25 is a side view of a material stop assembly of the vane cutting apparatus of FIG. 18 according to some aspects of the present disclosure.

FIG. 26 is a perspective view of a scrap bin of the vane cutting apparatus of FIG. 18 according to some aspects of the present disclosure.

FIG. 27 is a top, side, and perspective view of a mounting block assembly of the vane cutting apparatus of FIG. 18 according to some aspects of the present disclosure.

### DETAILED DESCRIPTION

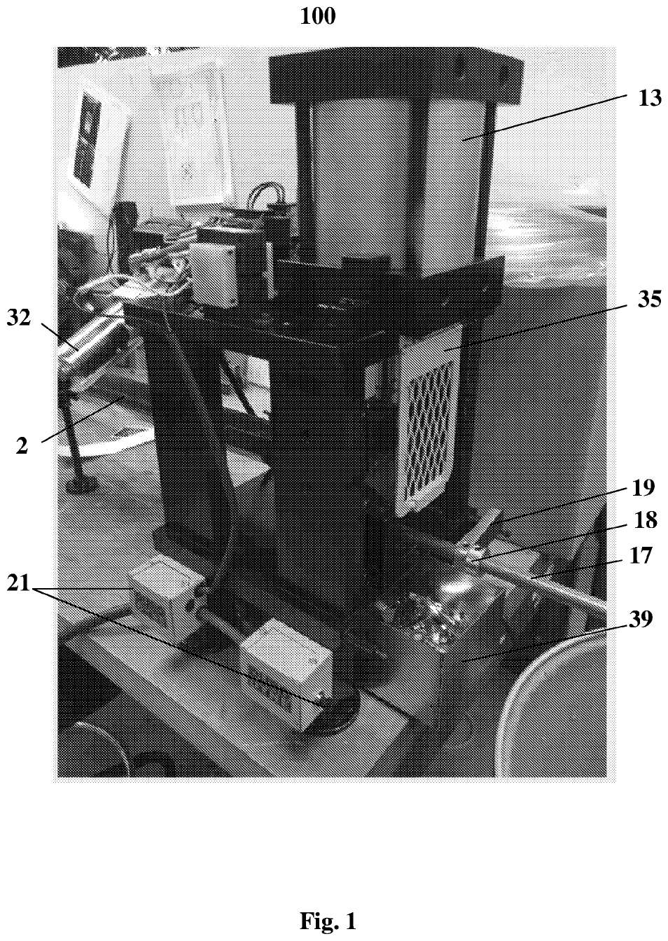

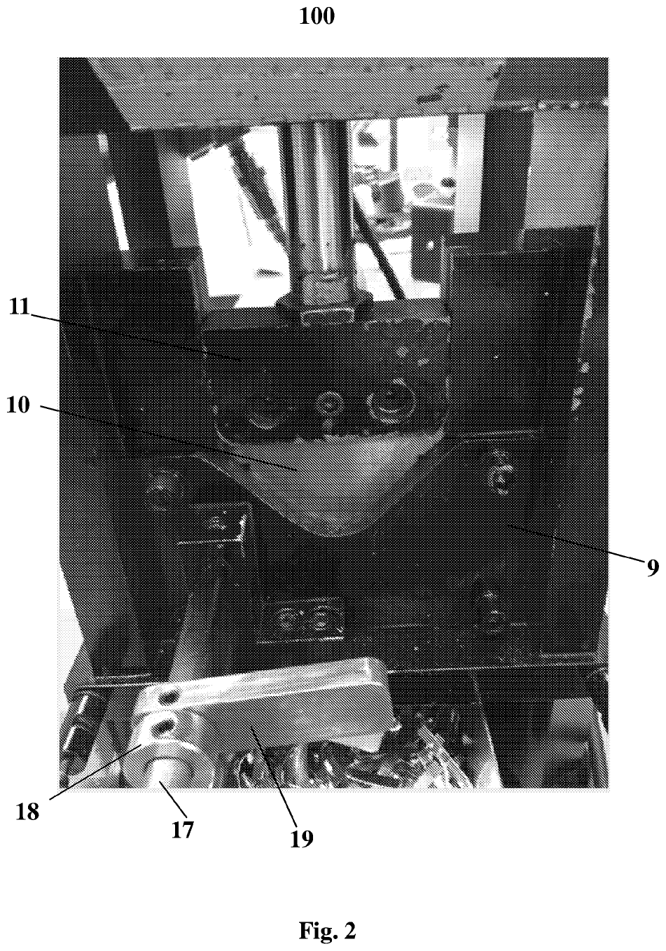

With reference now to FIGS. 1 and 2, a hollow turning vane cutting apparatus 100 is disclosed. Vane cutting apparatus 100 is configured for cutting hollow turning vanes for use in HVAC systems. Vane cutting apparatus 100 may be configured, for example, to cut 2″, 4″, or any other size hollow turning vanes. Vane cutting apparatus 100 is configured to cut the hollow turning vanes to a desired length for use in an HVAC system.

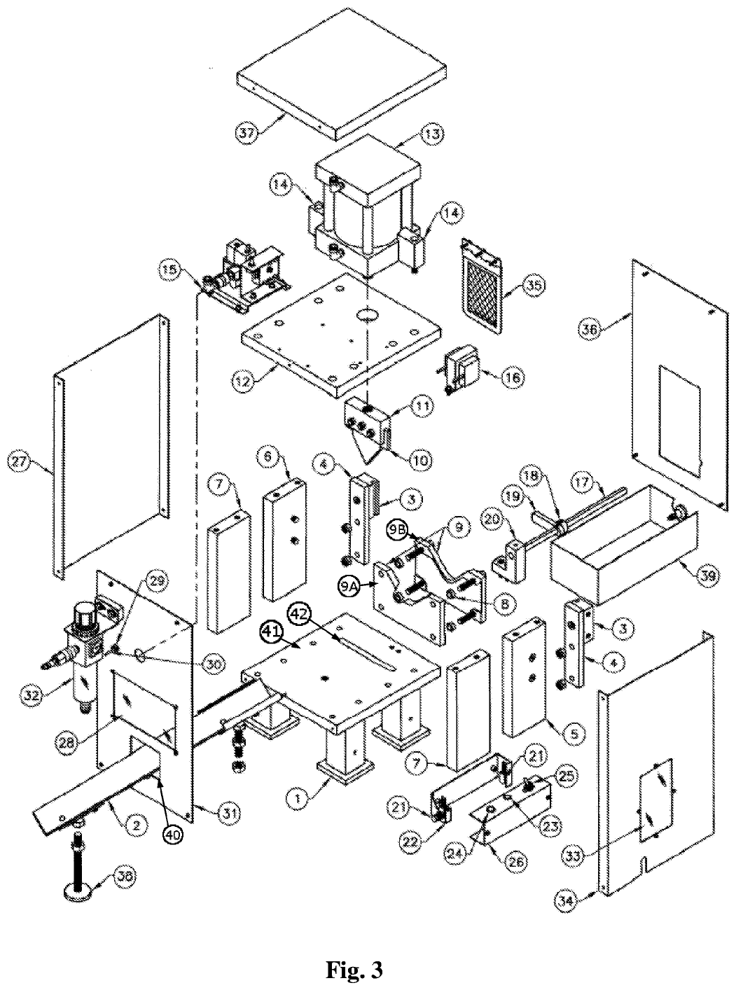

With reference now to FIG. 3, aspects of vane cutting apparatus 100 will now be disclosed. In some aspects, vane cutting apparatus may include any or all of the following components as illustrated in FIG. 3:
1)—Lower Plate Leg Weldment
2)—Material Feed Track Assembly
3)—Top Blade Guide
4)—Blade Support Block
5)—Upright Support with Mounting Holes-Control Side
6)—Upright Support with Mounting Holes-Non Control Side
7)—Upright Support
8)—Saddle Spacer
9)—2″/4″ Blade Saddle
9A)—First portion of blade saddle
9B)—Second portion of blade saddle
10)—2″/4″ Vane Cutter Blade
11)—2″/4″ Blade Holder
12)—Upper Plate
13)—Air Cylinder Assembly
14)—Cylinder Hold Clamp
15)—Sub-Component Chassis
16)—24 Volt Transformer
17)—Vane Stop Rod
18)—½″ Collar
19)—Vane Stop
20)—Adjustment Bar Block
21)—Momentary Switch
22)—Control Console
23)—Bushing
24)—Power Indicator Light
25)—On/Off Toggle Switch
26)—Control Console Cover
27)—Housing Panel-Non Control Side
28)—Window Housing Panel-Front
29)—Strain Relief
30)—110 Volt line Cord
31)—Housing Panel-Front
32)—Air Regulator Assembly
33)—Window Housing Panel: Control Side
34)—Housing Panel-Control Side
35)—Safety Gate
36)—Housing Panel-Rear
37)—Housing Top Cover
38)—Track Assembly Foot
39)—Scrap Bin
40)—Opening in housing-front panel
41)—Lower Plate
42)—Opening in lower plate
43)—Air intake port

In some aspects, lower plate weldment 1 is configured for attachment to a working surface such as a work bench, shop floor, or other working surface.

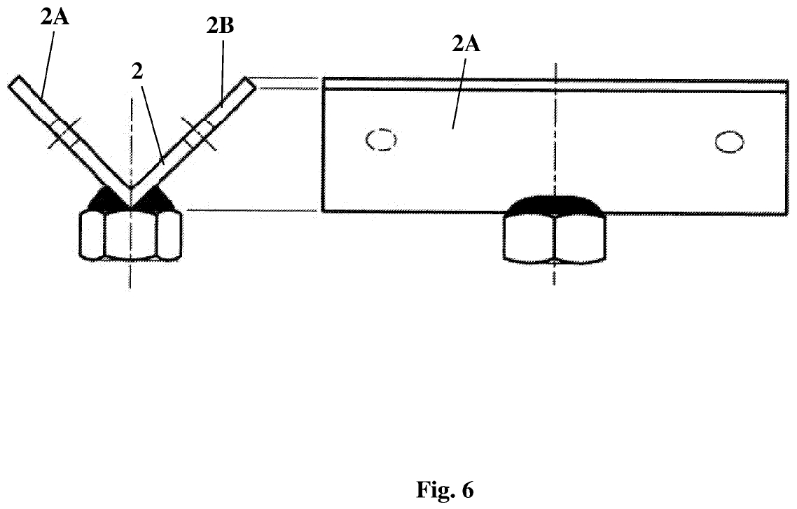

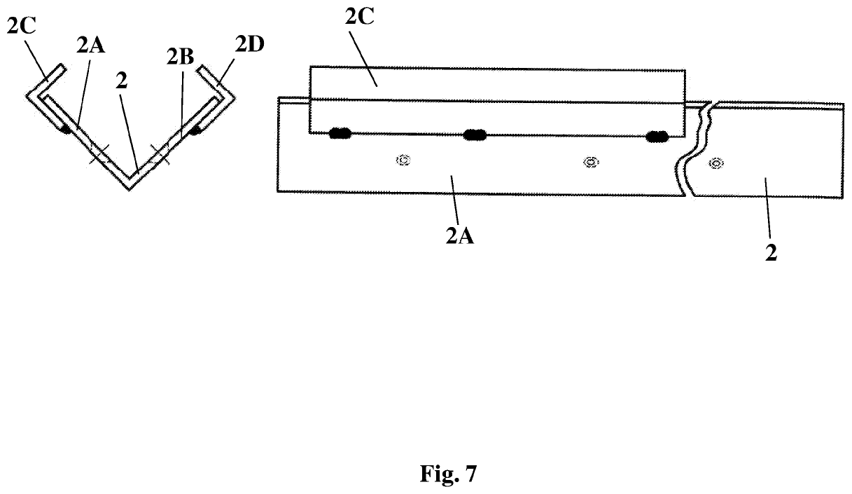

With reference now to FIGS. 1-3 and 5-8 and, in some aspects, material feed track 2 is configured to receive hollow turning vanes for cutting. For example, during operation, hollow turning vanes are placed on material feed track 2 by an operator. The operator pushes or slides the hollow turning vanes along material feed track 2 through an opening 40 in housing panel-front 31. As the hollow turning vane slides along material feed track 2, the hollow turning vane is supported by blade saddle 9 and pushes open safety gate 35 as it banks against vane stop 19.

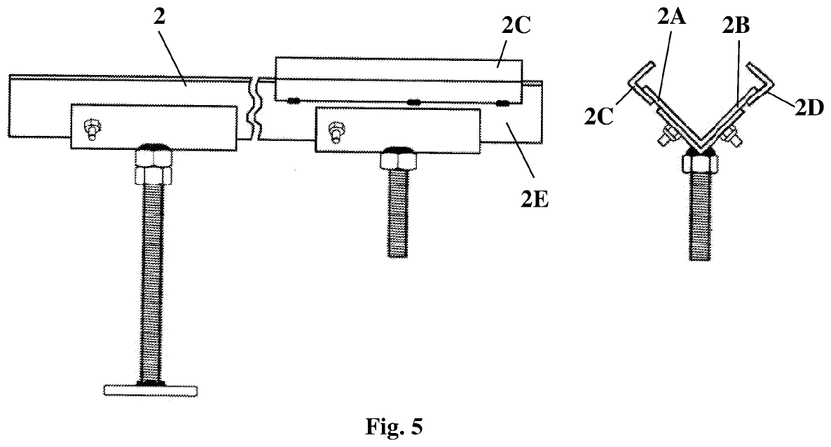

With reference now to FIGS. 5-7, in some aspects, material feed track 2 may include a first side 2A and a second side 2B. In some aspects, for example, first side 2A may be oriented at a 90 degree angle to second side 2B to support a 90 degree angle hollow turning vane. Material feed track 2 may also include brackets 2C and 2D extending along a distal portion 2E of material feed track 2 that are configured to retain a hollow turning vane within material feed track 2. In some aspects, bracket 2C may form a 90 degree angle and may be attached to an end of side 2A such that bracket 2C extends parallel to opposing side 2B of material feed track 2. In some aspects, bracket 2D may also form a 90 degree angle and may be attached to an end of side 2B such that bracket 2D extends parallel to opposing side 2A of material feed track 2. Brackets 2C and 2D are configured to inhibit or prevent a hollow turning vane inserted into material feed track 2 from escaping material feed track 2 during cutting.

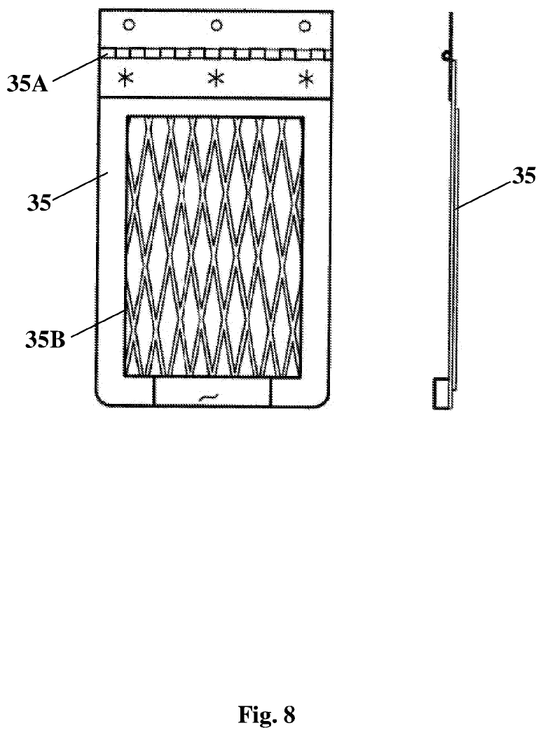

With reference now to FIG. 8, safety gate 35 includes hinge 35A and a mesh 35B. Safety gate 35 is gravity biased into a closed position, e.g., hanging from hinge 35A such that access to blade saddle 9 and vane cutter blade 10 is blocked or inhibited. When a hollow turning vane is inserted along material feed track 2 and positioned on saddle 9 abutting vane stop 19, safety gate 35 is at least partially opened or rotated about hinge 35A due to contact with the hollow turning vane. Once the hollow turning vane has been cut and falls into scrap bin 39, the contact with safety gate 35 is removed and safety gate 35 automatically falls back into the blocking position due to gravity. Mesh 35B allows the operator to see through safety gate 35 to view the blade saddle 9 and vane cutter blade 10 during and after cutting.

Referring again to FIGS. 1-3, vane stop 19, also called a material stop or a material stop assembly, is adjustable by the operator to set a desired length for the hollow turning vane. For example, vane stop 19 may slide along vane stop rod 17 to a desired length. In some aspects, vane stop rod 17 may include indices, e.g., numbers, measurements, a ruler, or other similar indices, to identify or indicate a final cut length for a hollow turning vane when the hollow turning vane is positioned against vane stop 19. Vane stop 19 may be locked in position using a collar 18. In some aspects, collar 18 may be ½″. In some aspects, collar 18 may include a locking mechanism such as, for example, a pin, screw, or other locking mechanism that may be actuated or used by the operator to secure collar 18 and vane stop 19 against vane stop rod 17. In some aspects, the collar 18 may be manually adjusted and locked in place using stop set screws without the need for electric or pneumatic tools.

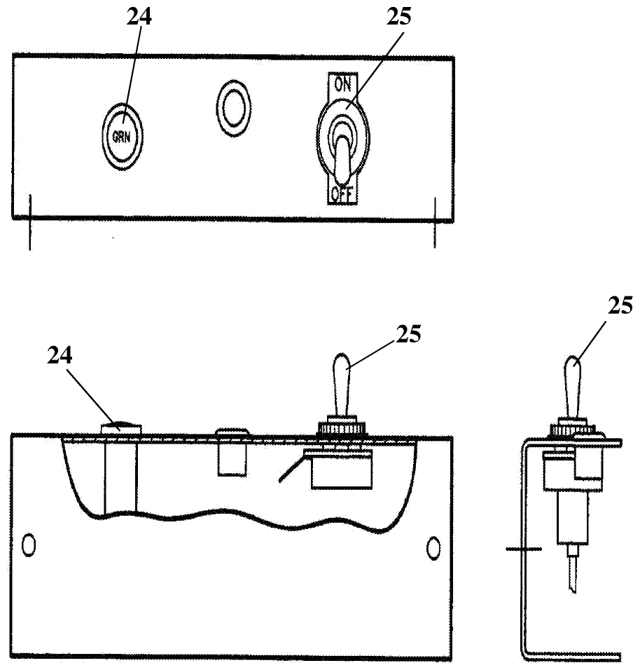

With reference now to FIGS. 1-4, 9, and 10, once the operator has positioned the hollow turning vane against vane stop 19, the operator may actuate on/off switch 25 from an “off” position to an “on” position to supply power to vane cutting apparatus 100. In some aspects, the on/off switch 25 may be actuated between the “off” and “on” positions at any time regardless of whether a hollow turning vane has been positioned against vane stop 19. Power may be supplied to vane cutting apparatus 100 via line cord 30. In some aspects, the power may be supplied at 110 volts. In some aspects, vane cutting apparatus 100 may be configured to operate using another voltage, for example, 120 volts, 230 volts, 220 volts, or any other voltage. In some aspects, vane cutting apparatus 100 may utilize a voltage converter (not shown) to convert any other voltage to 110 volts.

Once the operator has powered on vane cutting apparatus 100 using on/off switch 25, power indicator light 24 may illuminate to indicate that the vane cutting apparatus 100 is receiving power.

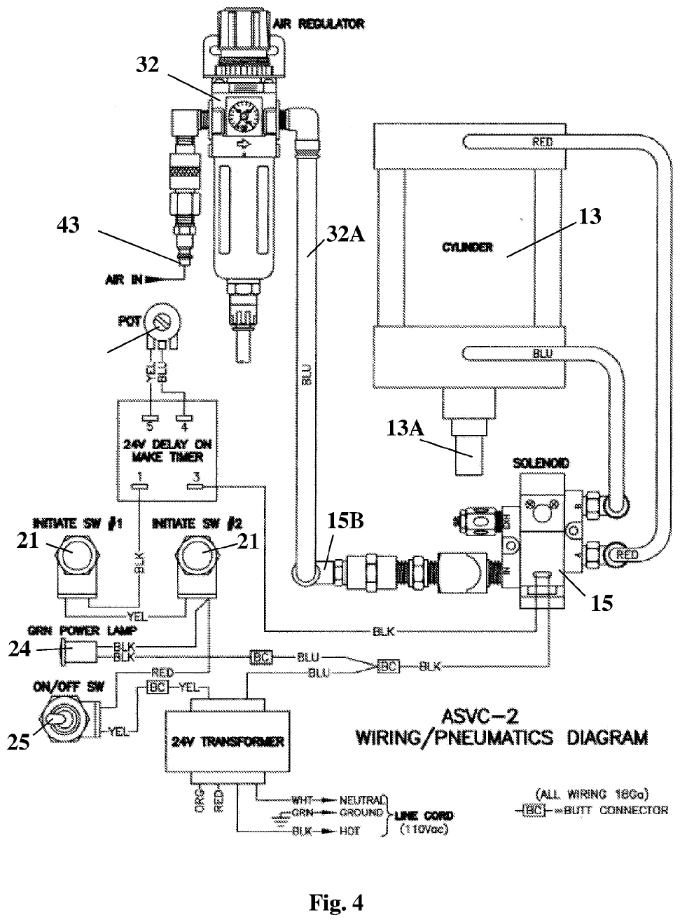

During setup or operation, the operator may also be required to connect or attach an air supply line (not shown) to air regulator assembly 32. For example, as illustrated in FIG. 4, an air supply line may be attached to air regulator assembly 32 at the air intake port 43. The air supply line will, in some aspects, supply air at a predetermined PSI, for example, 90 PSI. Air regulator assembly 32 may then regulate the supplied air and output the regulated air to air cylinder assembly 13 via sub-component chassis 15, for example at a regulated value of 70 PSI. Although described with reference to air, any fluid may be supplied via air supply line and used to actuate air cylinder assembly.

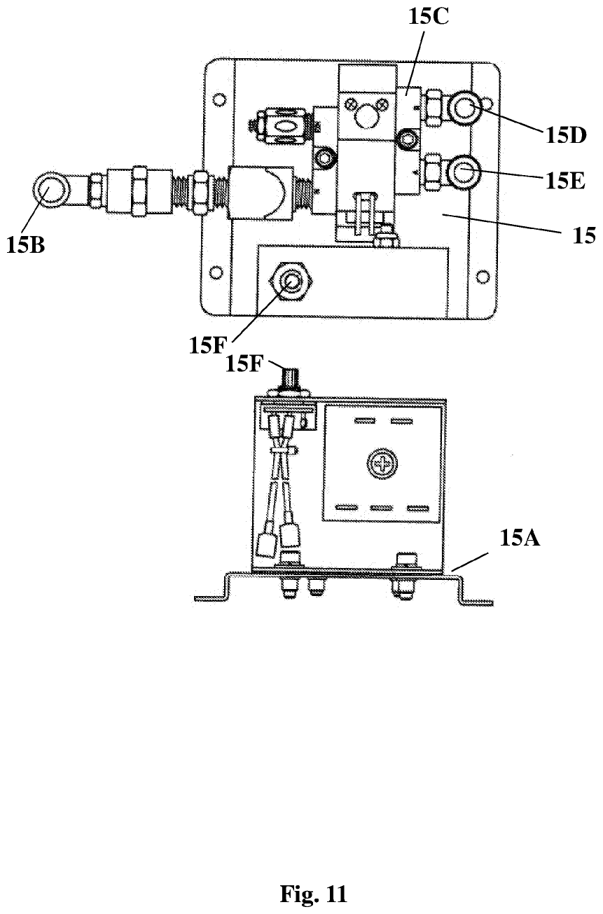

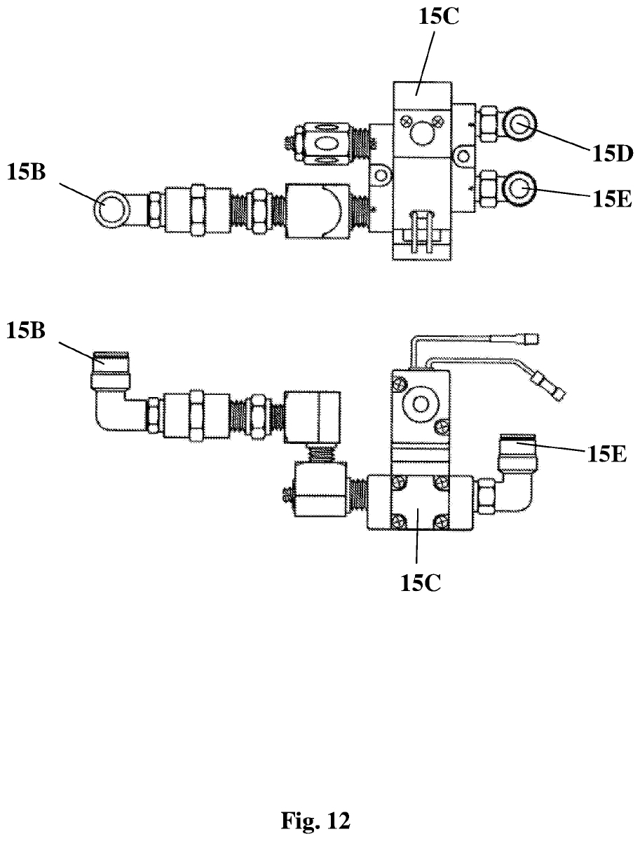

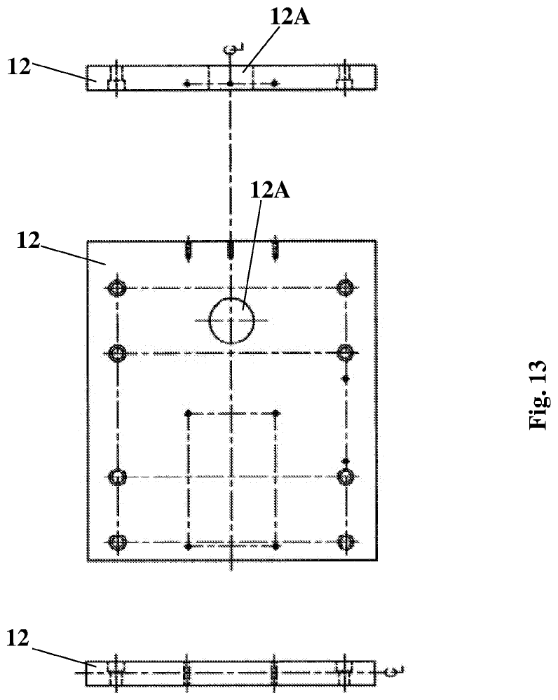

With reference to FIGS. 3, 4, and 11-13, sub-component chassis 15 is attached to vane cutting apparatus 100 using a component chassis 15A. An air supply line 32A from air regulator assembly 32 is attached to an intake port 15B. Air from the intake port 15B travels to a housing 15C with a pair of output ports 15D and 15E. Output ports 15D and 15E are connected to air cylinder assembly 13 and configured to supply air for pneumatic actuation of air cylinder assembly 13. Within housing 15C, an actuating mechanism (not shown), e.g., a solenoid, electric motor, or other similar actuating mechanism, controls the air flow to output ports 15D and 15E. For example, during activation, a solenoid associated with output port 15D may open airflow to air cylinder assembly 13 via output port 15D, causing air cylinder assembly 13 to pneumatically actuate vane cutter blade 10 to extend distally from air cylinder assembly 13 and cut a hollow turning vane positioned on blade saddle 9. Once cutting is complete, the solenoid associated with output port 15D may close and a solenoid associated with output port 15E may open airflow to air cylinder assembly 13 via output port 15E, causing air cylinder assembly 13 to pneumatically actuate vane cutter blade 10 to return proximally toward air cylinder assembly 13.

In some aspects, the actuating mechanism may be electrically activated by the activation of momentary switches 21 (FIG. 4). In some aspects, timing and aspects of the solenoids may be adjusted or controlled by a potentiometer 15F. For example, potentiometer 15F may control the stroke length of air cylinder assembly 13, e.g., opening the solenoid associated with output port 15D for a longer or shorter period of time. In some aspects, potentiometer 15F may control a timing delay between actuation of momentary switches 21 and the opening or closing of the solenoids. In some aspects, potentiometer 15F may control a timing between the cutting portion of the stroke, e.g., using output port 15D, and the return portion of the stroke, e.g., using output port 15E.

With reference again to FIGS. 1, 3, and 4, once vane cutting apparatus 100 has been powered on and the air supply has been attached, an operator may activate vane cutting apparatus 100 to cut the hollow turning vane positioned on blade saddle 9 against vane stop 19 by actuating momentary switches 21. Momentary switches 21 are positioned on either end of control consol 22 such that an operator will be unable to actuate both momentary switches 21 with a single hand. Instead, the operator is required to use both hands to actuate both momentary switches 21. This provides additional safety for the operator by ensuring that both of the operators hands, which are positioned against momentary switches 21, are not in the path of vane cutter blade 10 during activation.

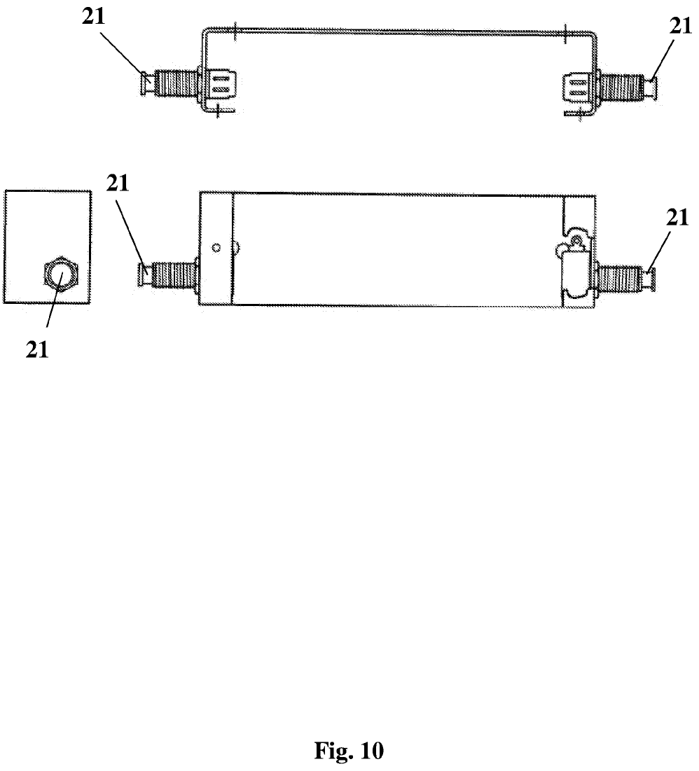

With reference now to FIGS. 4 and 10, actuation of both momentary switches 21 at the same time sends a signal to sub-component chassis 15 to open a flow path for the air from air regulator assembly 32 to travel to air cylinder assembly 13 as described above. When the air reaches air cylinder assembly 13, the air pneumatically actuates cylinder 13 to perform a cutting stroke. The cutting stroke of air cylinder assembly 13 causes vane cutter blade 10 to extend distally from air cylinder assembly 13 to cut the hollow turning vane positioned on blade saddle 9 before returning proximally toward air cylinder assembly 13 in a return stroke. In some aspects, each simultaneous actuation of momentary switches 21 may cause air cylinder assembly 13 to perform one stroke, e.g., a single cut and return motion. In some aspects, simultaneous actuation of momentary switches 21 may cause air cylinder assembly 13 to perform only the cut motion while the return motion is performed in response to one or both of momentary switches 21 becoming un-actuated (e.g., the operator has removed a hand from one or both of momentary switches 21).

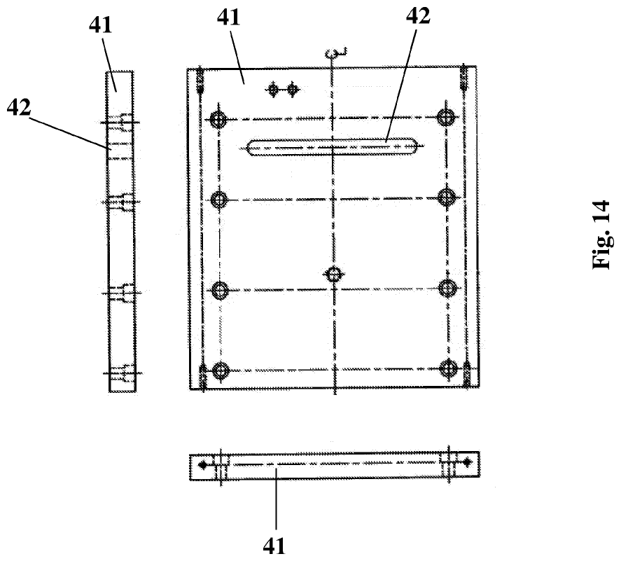

With reference now to FIGS. 3, and 13-17, vane cutter blade 10 is attached to blade holder 11. Blade holder 11 is mounted to a pneumatic piston arm 13A (FIG. 4) extending from air cylinder assembly 13 through an opening 12A in upper plate 12, for example, via screw fit, snap-fit, or in any other manner of attachment. During actuation, pneumatic piston arm 13A is actuated through opening 12A such that blade holder 11 and vane cutter blade 10, which are positioned distal of opening 12A relative to air cylinder assembly 13, are extended distally from opening 12A and air cylinder assembly 13 to cut a hollow turning vane positioned on blade saddle 9 and extend at least partially through opening 42 of lower plate 41.

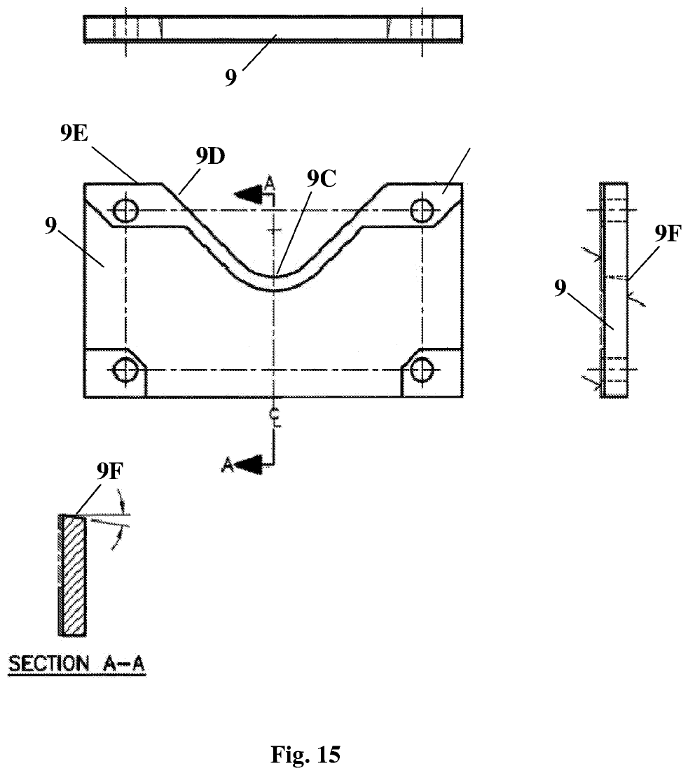

With reference now to FIG. 15, blade saddle 9 (portions 9A and 9B) defines an arcuate curvature 9C for receiving a hollow turning vane. In some aspects, for example, the wall 9D leading to the arcuate curvature 9C may be at an angle of 45 degrees to a top surface 9E. In some aspects, for example, arcuate curvature 9C may have a radius of 0.875. As seen in section A-A, Wall 9D and arcuate curvature 9C may include an incline 9F. In some aspects, incline 9F may be, for example, 8 degrees. Incline 9F assists vane cutting blade 10 in rolling the edge of the hollow turning blade that is cut by vane turning apparatus by providing an angled surface against which the hollow turning blade may be rolled.

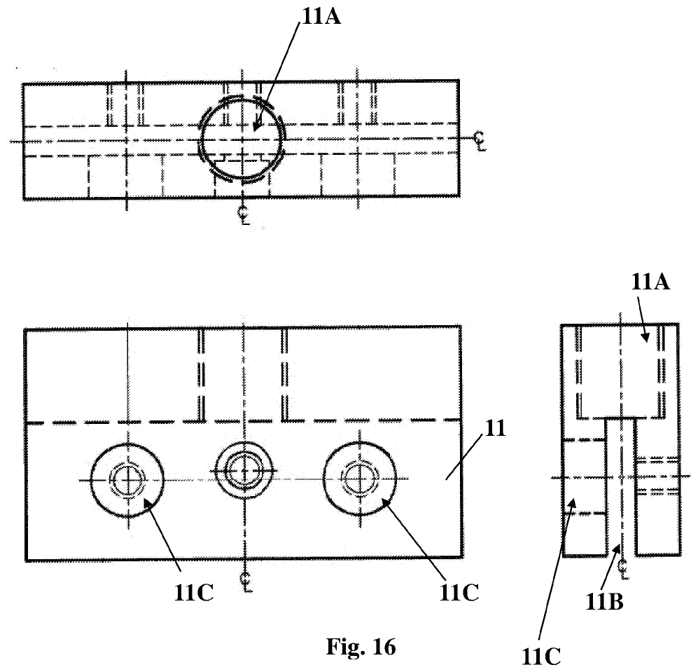

With reference now to FIG. 16, blade holder 11 a piston mounting bore 11A, a slot 11B for receiving a proximal portion of vane cutter blade 10, and mounting holes 11C for securing vane cutter blade 10 to blade holder 11. Piston mounting bore 11A is configured to received pneumatic piston 13A of air cylinder assembly 13 for securing blade holder 11 to air cylinder assembly 13. For example, piston mounting bore 11A and pneumatic piston 13A may be threaded such that blade holder 11 may be screwed onto pneumatic piston 13A.

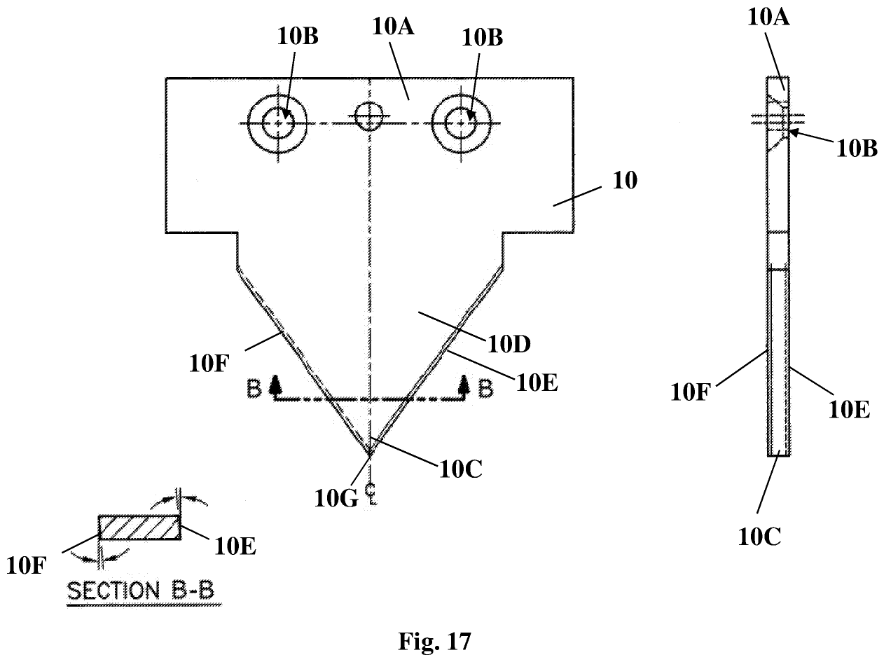

Slot 11B is configured to receive a proximal portion 10A (FIG. 17) of vane cutter blade 10 such that mounting holes 10B of vane cutter blade 10 align with mounting holes 11C of blade holder 11.

Mounting holes 11B are configured to receive a mounting screw (not shown) for mounting vane cutter blade 10 to blade holder 11. For example, a mounting screw may be inserted through mounting holes 11B and mounting holes 10B of vane cutter blade 10 to secure vane cutter blade 10 to blade holder 11, and to air cylinder assembly 13 via blade holder 11.

With reference now to FIG. 17, vane cutter blade 10 includes a proximal portion 10A and a distal portion 10C. Proximal portion 10A includes mounting holes 10B for mounting vane cutter blade 10 to blade holder 11. Distal portion 10C includes a reversible single stepped cutting blade 10D including blade edges 10E and 10F that are configured to roll the edges of a hollow turning vane as it is cut and a cutting point 10G. For example, the opposite angled blade edges 10E and 10F of cutting blade 10D provide angled surfaces for the hollow turning vane to be guided and formed into a rolled edge during the cutting process. Cutting blade 10D is resharpenable and has improved life of blade function as compared to prior methods. As illustrated in section B-B, blade edges 10E and 10F are single stepped and face opposite directions. This provides for re-use where, for example, vane blade cutter blade 10 may be reversed to prolong the life of cutting blade 10D.

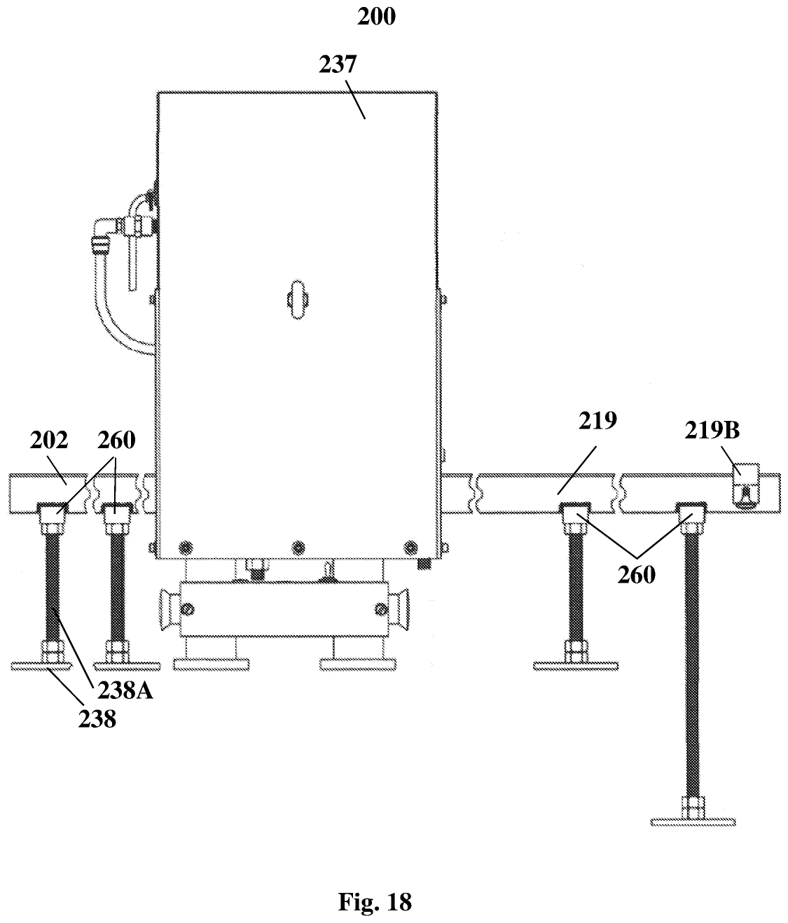

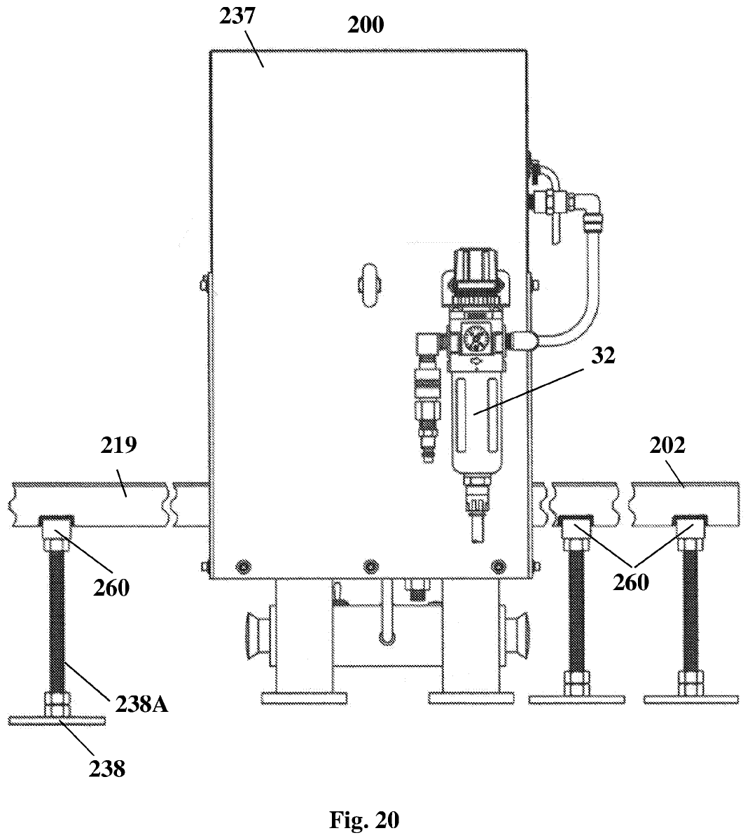

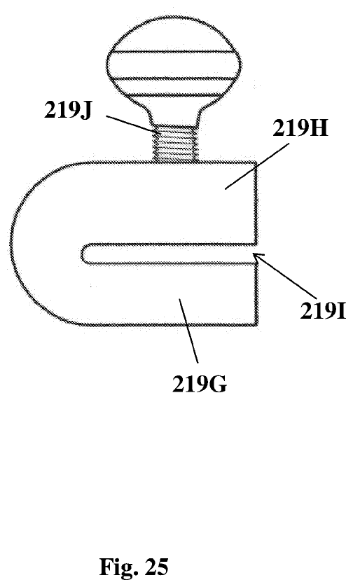

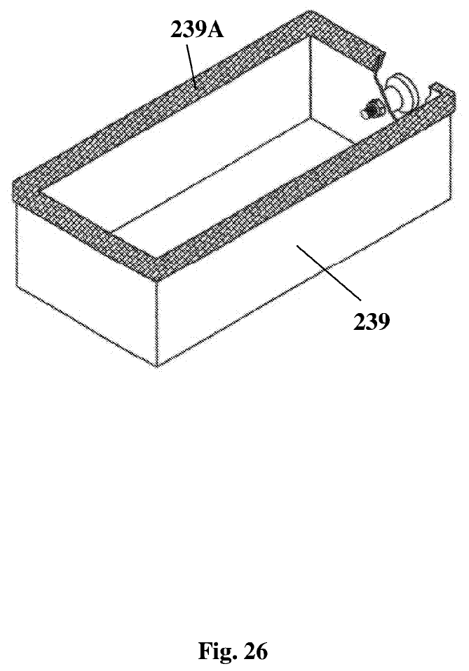

With reference now to FIGS. 18-27, a hollow turning vane cutting apparatus 200 is disclosed. Vane cutting apparatus 200 is configured for cutting hollow turning vanes for use in HVAC systems. Vane cutting apparatus 200 may be configured, for example, to cut 2″, 4″, or any other size hollow turning vanes. Vane cutting apparatus 200 is configured to cut the hollow turning vanes to a desired length for use in an HVAC system.

With reference now to FIGS. 18-22, aspects of vane cutting apparatus 200 will now be disclosed. In some aspects, vane cutting apparatus 200 may include any or all of the components of vane cutting apparatus 100 mentioned above and may function in a similar manner to vane cutting apparatus 100 as described above. For brevity, only features that are different between vane cutting apparatus 200 and vane cutting apparatus 100 will be described in more detail below.

Vane cutting apparatus 200 includes a material feed track 202, that functions in a similar manner to material feed track 2 as described above. For example, material feed track 202 is configured to receive hollow turning vanes for cutting. For example, during operation, hollow turning vanes are placed on material feed track 202 by an operator. The operator pushes or slides the hollow turning vanes along material feed track 202 through an opening 240 in housing panel-front 231. As the hollow turning vane slides along material feed track 202, the hollow turning vane is supported by blade saddle 209, pushes open safety gate 235, and rests on exit track 219.

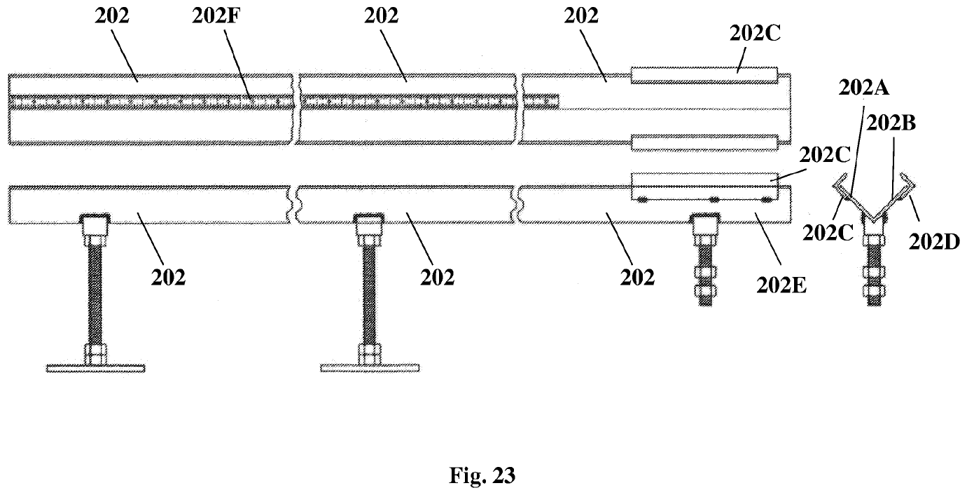

With reference now to FIG. 23, in some aspects, material feed track 202 may include similar features as material feed track 2. For example, material feed track 202 may include a first side 202A and a second side 202B. In some aspects, for example, first side 202A may be oriented at a 90 degree angle to second side 202B to support a 90 degree angle hollow turning vane. Material feed track 202 may also include brackets 202C and 202D extending along a distal portion 202E of material feed track 202 that are configured to retain a hollow turning vane within material feed track 202. In some aspects, bracket 202C may form a 90 degree angle and may be attached to an end of side 202A such that bracket 202C extends parallel to opposing side 202B of material feed track 202. In some aspects, bracket 202D may also form a 90 degree angle and may be attached to an end of side 202B such that bracket 202D extends parallel to opposing side 202A of material feed track 202. Brackets 202C and 202D are configured to inhibit or prevent a hollow turning vane inserted into material feed track 202 from escaping material feed track 202 during cutting.

In some aspects, material feed track 202 may also include measurement indicia 202F, for example, a tape measure, ruler, or other similar measuring indicia. When a user of vane cutting apparatus 100 positions a hollow turning vane in material feed track 202, the user may use the measurement indicia 202F to determine length of the hollow turning vane to be cut.

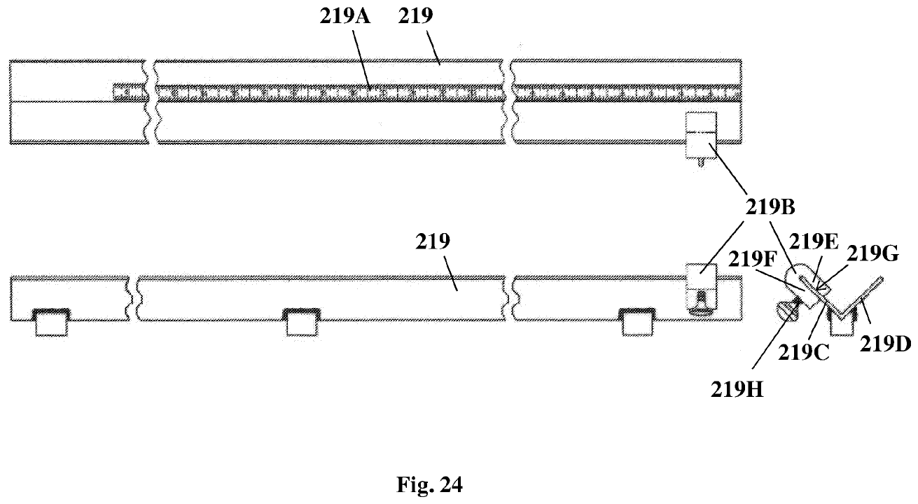

With reference now to FIG. 24, vane cutting apparatus 200 also includes an exit track 219. Exit track 219 may include measurement indicia 219A, for example, a tape measure, ruler, or other similar measuring indicia, and a material stop assembly 219B, also called a material stop or vane stop, that may be repositionable along exit track 219 to a desired length, for example, using measurement indicia 219A. For example, material stop assembly 219B may be positioned at a set length such that when the hollow turning vane rests on exit track 219, the hollow turning vane 219 may engage against or abut material stop assembly 219B. The hollow turning vane may then be cut, producing a piece of hollow turning vane that is the desired length as set by the material stop assembly 219B according to the measurement indicia 219A.

Exit track 219 includes a first side 219C and a second side 219D. In some aspects, for example, first side 219C may be oriented at a 90 degree angle to second side 219D to support a 90 degree angle hollow turning vane.

With reference now to FIGS. 18, 19, 22, 24, and 25, material stop assembly 219B includes a first portion 219E, a second portion 219F, and an opening or cavity 219G therebetween. Cavity 219G is configured to receive one of first and second sides 219C and 219D therein. Second portion 219F includes a screw hole (not shown) that is configured to receive a screw 219H. Screw 219H may be screwed through the screw hole (not shown) to engage against first or second side 219C, 219D that is received within cavity 219G to secure material stop assembly 219B to the first or second side 219C, 219D at the desired measurement location based on the measurement indicia 219A.

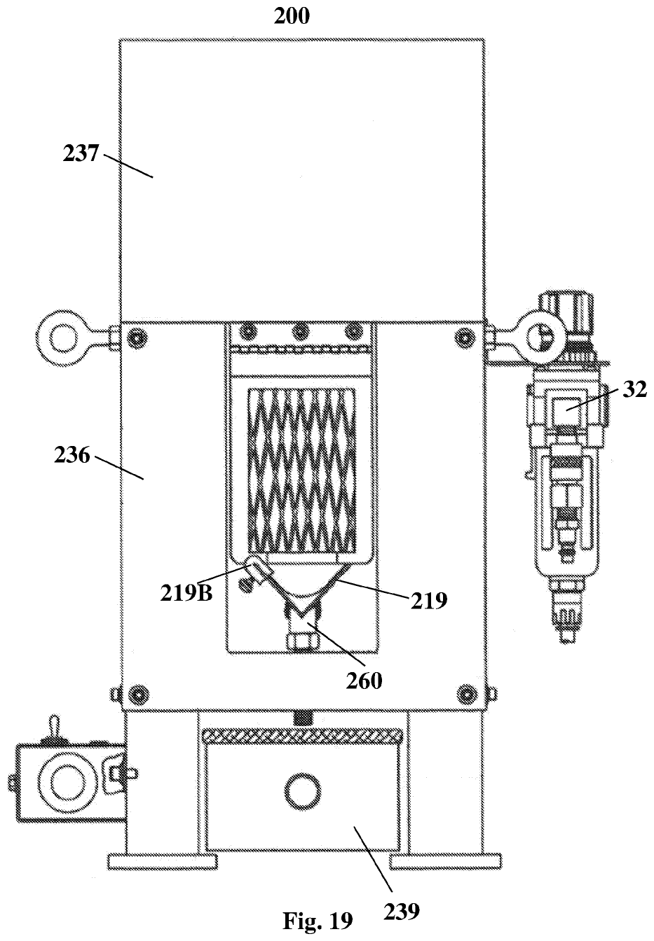

With reference now to FIGS. 19, 21, 22, and 26 vane cutting apparatus 200 may also include a scrap bin 239 that functions in a similar manner to scrap bin 39. In some aspects, scrap bin 239 may additionally include a protective trim 239A that is configured to protect the edges of scrap bin 239 from wear.

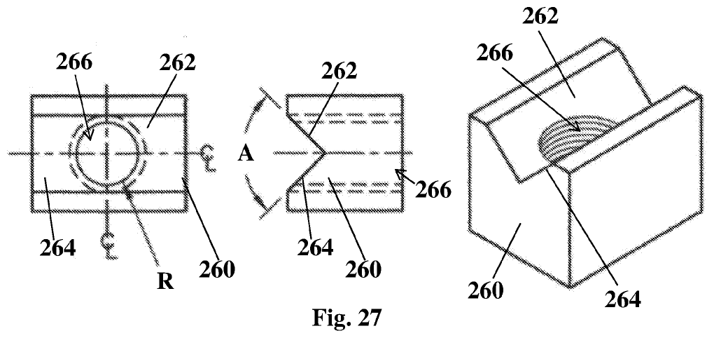

With reference now to FIGS. 18-20, 22, and 27, a mounting block assembly 260 of vane cutting apparatus 200 is illustrated. Mounting block assembly 260 includes a body 262 having a first side wall 264 and a second side wall 266. First and second sidewalls 264 and 266 are disposed at an angle to one another such that material feed track 202 and exit track 219 may be supported thereon. For example, if the sides 202A and 202B of material feed track 202 define an angle therebetween, e.g., 90 degrees, side walls 265 and 266 of mounting block assembly 260 may define the same angle, e.g., 90 degrees. For example, as illustrated in FIG. 27, the angle A of mounting block assembly 260 may be the same as the angle between sides 202A and 202B of material feed track 202. In some aspects, sides 219C and 219D of exit track 219 may define the same angle as sides 202A and 202B of material feed track 202 and the angle A of the mounting block assemblies 260 supporting each of material feed track 202 and exit track 219 may therefore be the same. In a case where the angle of the sides 219C and 219D of exit track 219 is different than the angle of sides 202A and 202B of material feed track 202, the angle A for the respective mounting block assemblies 260 to be used with each of material feed track 202 and exit track 219 may have different angles which correspond to their respective use.

Mounting block assembly 260 may further include a screw hole 266 including a radius R that is configured to receive a screw from a track assembly foot, e.g., a screw 238A if track assembly foot 238. Screw hole 266 of mounting block assembly 260 may also or alternatively be configured to receive a screw from track assembly foot 38 of FIG. 3. Mounting block assembly 260 may be screwed onto the threads of screw 238A until a desired height for supporting material feed track 202 or exit track 219 is achieved. Material feed track 202 or exit track 219 may then be positioned against sides 262 and 264 within the angle A such that they are supported by the respective mounting block assemblies 260. In some aspects, material feed track 220 or exit track 219 may be removably or permanently secured to mounting block assemblies 260. For example, material feed track 220 or exit track 219 may be removably or permanently secured to mounting block assembly 260 through any of a screw fit, snap fit, adhesive, welding, clamping, or in any other manner.

Additional example differences between vane cutting apparatus 100 and vane cutting apparatus 200 may include, for example, replacement of housing panel-non control side 27, housing panel-front 31, housing panel-control side 34, housing panel-rear 36, and housing top cover 37, with housing panel-front 231, housing panel-rear, and 236 housing top cover 237. For example, the number of panels may be reduced from five panels to three panels as illustrated in FIGS. 18-22. It is contemplated that vane cutting apparatus 100 and 200 may be modified to include either of the 3 panel and 5 panel designs without departing from the scope of the present disclosure.

Another example of a difference between vane cutting apparatus 100 and vane cutting apparatus 200 may include, for example, relocating the attachment of air regulator assembly 32 from the housing-panel front 31 as illustrated, for example in FIG. 3, to the non-control side of housing top cover 237, as illustrated, for example, in FIGS. 19-22. It is contemplated that vane cutting apparatus 100 and 200 may include either method of attachment for air regulator assembly 32 without departing from the scope of the present disclosure.

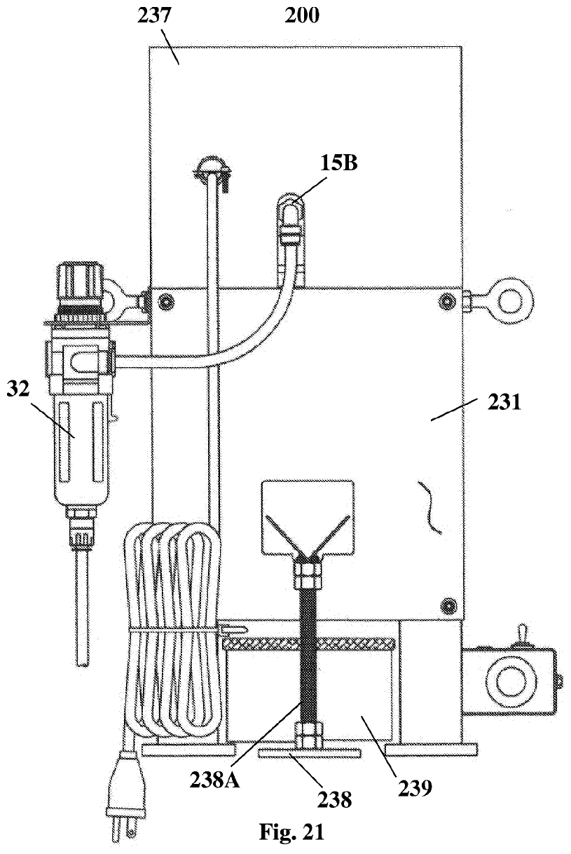

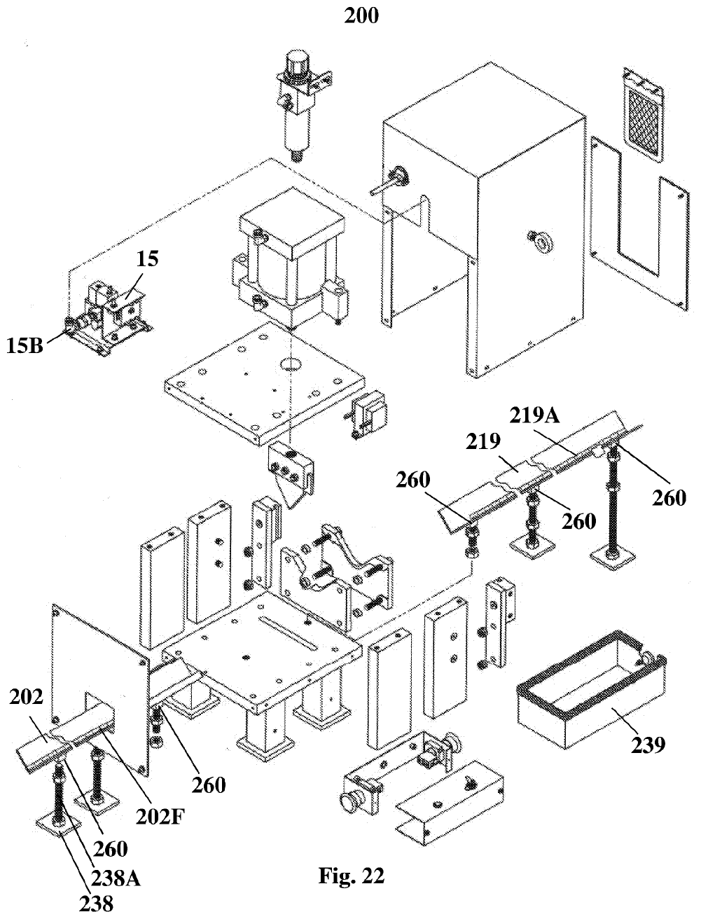

Another example of a difference between vane cutting apparatus 100 and vane cutting apparatus 200 may include, for example, the use of a channel in top cover 237, as illustrated, for example, in FIGS. 21 and 22, instead of the hole in housing panel-front 31 as illustrated, for example, in FIG. 3, for receiving the intake port 15B of the sub-component chassis 15 therethrough. It is contemplated that vane cutting apparatus 100 and 200 may include either method of receiving the intake port 15B through a panel without departing from the scope of the present disclosure.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A vane cutting apparatus comprising:
a fluid source;
a pneumatic piston fluidly coupled to the fluid source;
a vane cutter blade mechanically coupled to the pneumatic piston, the pneumatic piston configured to actuate the vane cutter blade between at least a proximal position and a distal position, actuation of the vane cutter blade toward the distal position configured to cut a hollow turning vane;
a fluid control mechanism fluidly disposed between the fluid source and the pneumatic piston, the fluid control mechanism configured to control a supply of fluid from the fluid source to the pneumatic piston; and
an actuation mechanism electrically coupled to the fluid control mechanism and activatable to cause the fluid control mechanism to supply fluid to the pneumatic piston, the pneumatic piston configured to actuate the vane cutter blade when the fluid control mechanism supplies the fluid to the pneumatic piston.

2. The vane cutting apparatus of claim 1, further comprising a blade saddle, the blade saddle including a first member and a second member, the blade saddle configured to receive at least a portion of the vane cutter blade between the first member and the second member when the vane cutter blade is actuated toward the distal position.

3. The vane cutting apparatus of claim 2, wherein the blade saddle comprises an arcuate portion, the arcuate portion configured to support the hollow turning vane and inhibit deformation of the hollow turning vane when the vane cutter blade cuts the hollow turning vane.

4. The vane cutting apparatus of claim 1, further comprising a material stop, the material stop configured to abut the hollow turning vane when the hollow turning vane is positioned for cutting by the vane cutter blade, a position of the material stop being adjustable to set a desired length of the hollow turning vane.

5. The vane cutting apparatus of claim 4, further comprising an exit track that is configured to support the hollow turning vane on a downstream side of the cutter blade, the position of the material stop being adjustable relative to the exit track to set the desired length, the material stop configured for securement to the exit track to inhibit movement of the material stop relative to the exit track.

6. The vane cutting apparatus of claim 5, wherein the exit track further comprises measurement indicia, the position of the material stop being adjustable relative to the measurement indicia to set the desired length of the hollow turning vane based on the measurement indicia.

7. The vane cutting apparatus of claim 1, further comprising a material feed track that is configured to support the hollow turning vane on an upstream side of the cutter blade.

8. The vane cutting apparatus of claim 7, wherein the material feed track comprises a first side and a second side at an angle to the first side, the first and second sides configured to support the hollow turning vane therebetween when the hollow turning vane is inserted into the vane cutting apparatus in a downstream direction.

9. The vane cutting apparatus of claim 8, wherein the first side includes a first flange attached to an end thereof and the second side includes a second flange attached to an end thereof, the first and second flanges configured to, when the hollow turning vane is supported on the first and second sides and proximate to the first and second flanges, inhibit removal of the hollow turning vane from the material feed track in a direction orthogonal to the downstream direction.

10. A vane cutting apparatus comprising:
a blade saddle comprising a first member and a second member and configured to support a hollow turning blade when the hollow turning blade is received within the vane cutting apparatus;
a pneumatic piston fluidly coupled to a fluid source; and
a vane cutter blade mechanically coupled to the pneumatic piston, the pneumatic piston configured to actuate the vane cutter blade between at least a proximal position and a distal position, at least a portion of vane cutter blade being received between the first and second members of the blade saddle when in the distal position, actuation of the vane cutter blade toward the distal position configured to cut the hollow turning vane supported by the blade saddle.

11. The vane cutting apparatus of claim 10, further comprising:
a fluid control mechanism fluidly disposed between the fluid source and the pneumatic piston, the fluid control mechanism configured to control a supply of fluid from the fluid source to the pneumatic piston; and
an actuation mechanism electrically coupled to the fluid control mechanism and activatable to cause the fluid control mechanism to supply fluid to the pneumatic piston, the pneumatic piston configured to actuate the vane cutter blade when the fluid control mechanism supplies the fluid to the pneumatic piston.

12. The vane cutting apparatus of claim 10, wherein the blade saddle comprises an arcuate portion, the arcuate portion configured to support the hollow turning vane and inhibit deformation of the hollow turning vane when the vane cutter blade cuts the hollow turning vane.

13. The vane cutting apparatus of claim 10, further comprising a material stop, the material stop configured to abut the hollow turning vane when the hollow turning vane is positioned for cutting by the vane cutter blade, a position of the material stop being adjustable to set a desired length of the hollow turning vane.

14. The vane cutting apparatus of claim 13, further comprising an exit track that is configured to support the hollow turning vane on a downstream side of the cutter blade, the position of the material stop being adjustable relative to the exit track to set the desired length, the material stop configured for securement to the exit track to inhibit movement of the material stop relative to the exit track.

15. The vane cutting apparatus of claim 14, wherein the exit track further comprises measurement indicia, the position of the material stop being adjustable relative to the measurement indicia to set the desired length of the hollow turning vane based on the measurement indicia.
